(19) United States
(12) Patent Application Publication
(10) Pub. No.: US 2007/0217076 A1
(43) Pub. Date: Sep. 20, 2007

(54) Nanoscale machined electrode and workpiece, and method of making the same

(75) Inventors: Sanjay C. Sheth, Saratoga, CA (US); James S. Lee, San Jose, CA (US)

Correspondence Address: SEAGATE TECHNOLOGY c/o MOFO NOVA, 1650 TYSONS BOULEVARD, SUITE 300, MCLEAN, VA, 22102, US

(73) Assignee: SEAGATE TECHNOLOGY LLC, Scotts Valley, CA (US)

(21) Appl. No.: 11/374,972

(22) Filed: Mar. 15, 2006

(51) Int. Cl. G11B 5/60

(52) U.S. Cl. 360/230

(57) ABSTRACT

The invention relates to motor bearing components with features such as fine groove pitch (<100 microns), fine feature widths (<25 microns), varying groove depths and surface profiles in 3D for optimum bearing performance. A method for manufacturing the workpiece, the electrode design features to make the final part and the method for manufacturing such an electrode are disclosed. An electrode including a conductive block having the desired profile is disclosed. The electrode of the embodiments of the invention could be made out of a wide range of materials including hard and difficult to machine materials. The electrode can be made out of a solid blank, or a sleeve with hollow core or a sleeve with a filled core. Such an electrode can be used for achieving optimized groove geometry on the workpiece. The electrode of the embodiments of the invention could also be made by method of manufacturing including formation of a groove pattern on a surface of a hollow conductive block by laser ablation of portions of the hollow conductive block and with or without formation of a dielectric material in the groove pattern. Additional methods involving photo-polymerization, selective ablation, plating and reverse ECM for recessed lands are disclosed.

### FIELD OF THE INVENTION

The present invention relates to a nanoscale machined electrode and a workpiece such as thrust and journal of a motor of a disk drive.

### BACKGROUND

Magnetic discs with magnetizable media are used for data storage in most all computer systems. Current magnetic hard disc drives operate with the read-write heads only a few nanometers above the disc surface and at rather high speeds, typically a few meters per second.

Generally, the discs are mounted on a spindle that is turned by a spindle motor to pass the surfaces of the discs under the read/write heads. The spindle motor generally includes a shaft fixed to a base plate and a hub, to which the spindle is attached, having a sleeve into which the shaft is inserted. Permanent magnets attached to the hub interact with a stator winding on the base plate to rotate the hub relative to the shaft. In order to facilitate rotation, one or more bearings are usually disposed between the hub and the shaft. An alternate design uses a rotating shaft configuration. Here the sleeve is attached to the base plate.

FIG. 1 shows a schematic of a magnetic disc drive for which a spindle motor having a fluid dynamic bearing manufactured by the method and apparatus of the present invention is particularly useful. Referring to FIG. 1, a disc drive 100 typically includes a housing 105 having a base 110 sealed to a cover 115 by a seal 120. The disc drive 100 has a spindle 130 to which are attached a number of discs 135 having surfaces 140 covered with a magnetic media (not shown) for magnetically storing information. A spindle motor (not shown in this figure) rotates the discs 135 past read/write heads 145 which are suspended above surfaces 140 of the discs by a suspension arm assembly 150. In operation, spindle motor rotates the discs 135 at high speed past the read/write heads 145 while the suspension arm assembly 150 moves and positions the read/write heads over one of a several radially spaced tracks (not shown). This allows the read/write heads 145 to read and write magnetically encoded information to the magnetic media on the surfaces 140 of the discs 135 at selected locations.

Over the years, storage density has tended to increase and the size of the storage system has tended to decrease. This trend has lead to greater precision and lower tolerance in the manufacturing and operating of magnetic storage discs. For example, to achieve increased storage densities the read/write heads must be placed increasingly close to the surface of the storage disc. This proximity requires that the disc rotate substantially in a single plane. A slight wobble or run-out in disc rotation can cause the surface of the disc to contact the read/write heads. This is known as a “crash” and can damage the read/write heads and surface of the storage disc resulting in loss of data.

From the foregoing discussion, it can be seen that the bearing assembly which supports the storage disc is of considerable importance. One typical bearing assembly comprises ball bearings supported between a pair of races which allow a hub of a storage disc to rotate relative to a fixed member. However, ball bearing assemblies have many mechanical problems such as wear, run-out and manufacturing difficulties. Moreover, resistance to operating shock and vibration is poor because of low damping.

One alternative bearing design is a hydrodynamic bearing. In a hydrodynamic bearing, a lubricating fluid such as air or liquid provides a bearing surface between a fixed member of the housing and a rotating member of the disc hub. In addition to air, typical lubricants include oil or other fluids. Hydrodynamic bearings spread the bearing interface over a large surface area in comparison with a ball bearing assembly, which comprises a series of point interfaces. This is desirable because the increased bearing surface reduces wobble or run-out between the rotating and fixed members. Further, the use of fluid in the interface area imparts damping effects to the bearing which helps to reduce non-repeat run out.

Dynamic pressure-generating grooves (i.e., hydrodynamic grooves) disposed on journals, thrust, and conical hydrodynamic bearings generate localized area of high fluid pressure and provide a transport mechanism for fluid or air to more evenly distribute fluid pressure within the bearing, and between the rotating surfaces.

FIG. 2A is a sectional side view of a spindle motor 155 of a type which is useful in disc drives 100. Typically the spindle motor 155 includes a rotatable hub 160 having one or more magnets 165 attached to a periphery thereof. The magnets 165 interact with a stator winding 170 attached to the base 110 to cause the hub 160 to rotate. The hub 160 is supported on a shaft 175 having a thrust plate 180 on an end. The thrust plate 180 can be an integral part of the shaft 175, or it can be a separate piece which is attached to the shaft, for example, by a press fit. The shaft 175 and the thrust plate 180 fit into a sleeve 185 and a thrust plate cavity 190 in the hub 160. A counter plate 195 is provided above the thrust plate 180 resting on an annular ring 205 that extends from the hub 160. An O-ring 210 seals the counter plate 195 to the hub 160. FIG. 2A is one possible configuration of a spindle motor. Other possible configurations include a spindle motor having a conical shaft bearing such as that shown in FIG. 2D.

A fluid, such as lubricating oil or a ferromagnetic fluid fills interfacial regions between the shaft 175 and the sleeve 185, and between the thrust plate 180 and the thrust plate cavity 190 and the counter plate 195. One or more of the thrust plate 180, the thrust plate cavity 190, the shaft 175, the sleeve 185, or the counter plate 195 have pressure generating grooves (not shown in this figure) formed in accordance with the present invention to create fluid dynamic bearings 220, 225. Grooves can be formed in an outer surface 215 of the shaft 175 or on the sleeve 185. More preferably, the grooves in the outer surface 215 of the shaft 175 form one or more fluid dynamic journal bearings 225 having dynamic cushions that rotatably support the hub 160 in a radial direction. Also, journal bearing can have grooves on shaft or sleeve or combination.

FIGS. 2B and 2C are a vertical sectional view and top plan view, respectively, of a hub and sleeve combination illustrating the grooves which establish the hydrodynamic bearings used to support the sleeve and hub for rotation relative to shaft 175. In accordance with design principles well known in this field, the sleeve 185 supports on its outer surface a hub 160 which in turn will support one or more discs (not shown) for rotation. The internal surface of the main bore of sleeve 185 includes a pair of sets of grooves 212, 214 which in cooperation with the surface of the shaft and the intervening fluid (not shown) will form the journal bearings which are used to support the hub 160 for rotation about the shaft 175.

Typically, such a design also includes a thrust plate supported on one end of the shaft (and shown 180 in FIG. 2A). A recess 216 is provided for the thrust plate 180; a second recess 218 is provided for the counter plate 195 which overlies the thrust plate in the assembled motor and is used to define the hydrodynamic bearing gap with the upper surface of the thrust plate. The lower surface 219 of the counter plate 195 faces an axially outer surface 221 of the thrust plate 180. Either the thrust plate 180 surface or the surface of the counter plate 195 also includes a set of grooves 222 (FIG. 2B) which in this case are in the shape of a succession of chevrons which cooperate with the outer surface 221 of the thrust plate 150 to create a pressure gradient which will support the thrust plate 180 and counter plate 195 for smooth relative rotation. This also prevents tilting of the hub 160 and sleeve 105 relative to the thrust plate 180 and the shaft 175 to which it is affixed so the hub 160 rotates with great stability relative to around the shaft 175.

FIG. 2D is vertical sectional view of a hub 200 supported by dual conical and journal bearings for rotation about a shaft (not shown). The hub 200 is integrated with the sleeve whose internal surfaces define the grooves which form the hydrodynamic bearing which supports the hub 200 for rotation. As is well-known in this technology, a shaft (not shown) is inserted within the hub 200 and has dual conical surfaces which face the conical regions 210, 212 at the upper and lower ends of the bearing region. The shaft would further include a smooth center section which would cooperate with the journal bearings defined by the grooved regions 214, 216. As is well-known in this field of fluid dynamic bearings, fluid will fill the gap between the stationary shaft and the inner grooved surfaces of the sleeve. As the sleeve rotates, under the impetus of interaction between magnets mounted on an inner surface of the hub which cooperate with windings supported from the base of the hub, pressure is built up in each of the grooved regions. In this way, the shaft easily supports the hub 200 and disc 202 for constant high speed rotation. The pressure generating grooves on the inner surface of the sleeve can easily be seen in FIG. 2D. They include, in the preferred example, two sets of grooves 230, 232 for the upper cone and a corresponding set 234, 236 for the lower cone. This particular design also utilizes two journal bearings 240, 242 to further stabilize the shaft.

Considering fluid dynamic bearings, the importance of the accuracy of grooves is that a fluid dynamic bearing generally comprises two relatively rotating members having juxtaposed surfaces between which a layer or film or fluid is maintained to form a dynamic cushion an antifriction medium. To form the dynamic cushion, at least one of the surfaces, in this case the interior surface of the hub and sleeve is provided with grooves which induce fluid flow in the interfacial region and generate a localized region of dynamic high pressure. The grooves are separated by raised lands or ribs. It is readily apparent that it can be extremely difficult to form grooves having these small dimensions that are relatively closely packed on a surface. To this end, the work piece, which in this case is the hub of FIG. 2D, is placed in a grooving device to form grooves in the workpiece.

The shape of the hydrodynamic grooves is dependant on the pressure uniformity desired. The quality of the fluid displacement and therefore the pressure uniformity is generally dependant upon the groove depth and dimensional uniformity. Controlled gradient in groove depth coupled with groove width gradient can provide desired pressure profile on the bearing surface.

As the result of the above problems, electrochemical machining (ECM) of grooves in a hydrodynamic bearing has been developed. Broadly described, ECM is a process of removing material metal without the use of mechanical or thermal energy. Basically, electrical energy is combined with a chemical to form an etching reaction to remove material from the hydrodynamic bearing to form hydrodynamic grooves thereon. To carry out the method, direct current is passed between the workpiece (e.g., counter plate, sleeve journal, or a conical bearing) which serves as an anode and the electrode, which typically carries the pattern to be formed and serves as the cathode, the current being passed through a conductive electrolyte which is between the two surfaces. At the anode surface, electrons are removed by current flow, and the metallic bonds of the molecular structure at the surface are broken. These atoms go into solution, with the electrolyte as metal ions and form metallic hydroxides. These metallic hydroxide (MOH) molecules are carried away to be filtered out. However, this process raises the need to accurately and simultaneously place grooves on a surface across a gap which must be very accurately measured, as the setting of the gap will determine the rate and volume at which the metal ions are carried away. Even in simple structures, this problem can be difficult to solve. When the structure is the interior surface of a conical bearing, the setting of the gap width can be extremely difficult. Manufacturability issues associated with conical parts often make it difficult to control the diameter of the cones. Due to mechanical tolerances, the workpiece may be misaligned with the electrode causing an uneven gap and a correspondingly uneven depth hydrodynamic groove. Therefore, it is difficult to make a tool with fixed electrodes that will guarantee a continued consistent workpiece to electrode gap to form dimensionally consistent hydrodynamic grooves.

Advanced groove patterns on thrust and journal are currently manufactured by an ECM process. The electrode used in the ECM process is made of high conductivity material and usually has a cylindrical shape with workpiece surface machined to reflect 3D pattern of a particular shape and depths.

The ECM process uses a shaped electrode to supply electrical flux fields thru an electrolyte to cause metal removal from the work piece in the areas influenced by these fields. The electrode has regions of conducting material separated by regions of insulating material. The shape and pattern of these regions is generally in the reverse image of the areas to be machined by the electrochemical action. Machining occurs in the zones of the conducting region and is restricted in the zones of insulating material. These electrodes may be complex and multidimensional in shape.

Fabrication of these electrodes is dependent on techniques that allow construction of alternating zones of conducting and insulating materials. Typical restrictions in fabrication capability include limited sizes of traditional machine cutting tools and capability to form single piece multidimensional structures. Other methods of fabrication might include photolithography, which may have restrictions in structure shape, or may be less cost effective due to multitude of steps involved.

Current FDB motors use ECM process to put grooves on thrust and journal bearings. Typically, a milling process is used for machining grooves on the electrode. By the conventional processes of milling grooves in the electrodes, it is difficult to control groove width, depth and separation between grooves.

Furthermore, current FDB motors use ECM process to put grooves on journal bearings by machining grooves on the electrode. The grooves are then potted with insulating epoxy. The potted electrode requires follow-up machining or grinding operation to remove excess insulation (FIG. 9).

There is a need for improved electrodes and method of manufacturing the same to provide a reliable method and apparatus for forming hydrodynamic grooves that is accurate and cost effective.

### SUMMARY OF THE INVENTION

The embodiments of the invention relate to the following:

Components (workpiece) of fluid dynamic bearing motors with high groove pitch. Pitch of less than 100 microns and feature widths less than 10 microns are feasible.

A workpiece which is typically grooved with electrode and/or ECM process. Additionally embodiments of this invention can be used for putting grooves directly on workpiece.

Conducting portions (lands) on the electrode which can be convex shaped to create uniform current flow/density leading to flatter lands and sharper channel walls on the workpiece (FIG. 8).

Conducting portions (lands) on the electrode which can be shaped to consequently create any desired land or groove geometry on the workpiece. This is feasible in 3 dimensions where the radial profile, groove depth, and other features of the workpiece can be selectively altered in 3 dimensions.

ECM processes for any shape electrode or a workpiece including for bearing surfaces such as thrust, journal, and conical or for non bearing surfaces or workpiece.

Optimized electrode geometry—optimized for electrical factors, electrolyte chemistry dynamics, and electrolyte flow dynamics coupled with tighter machining gap between workpiece and electrode, ultra-short pulsing (time) during ECM process to help create precise and optimized geometry on the workpiece.

An embodiment of the invention relates to electrode comprising a conductive block having a first opening though the conductive block and a second opening through the conductive block, the second opening traversing from the first opening to a surface of the conductive block. Preferably, the first opening does not contain a solid plug and the second opening is configured to allow the flow of a fluid through the second opening. Preferably, the first opening contains a solid plug comprising a non-conducting material. Preferably, the electrode is configured to form a groove pattern on a workpiece by an electrochemical machining process. Preferably, the surface of the conductive block comprises a groove pattern comprising grooves having a feature width of 25 microns or less. Preferably, the surface of the conductive block comprises a groove pattern comprising grooves having a feature width 12 microns or less. Preferably, the first opening and the second opening contain no dielectric material. Preferably, the electrode is configured to form a groove pattern in a workpiece at substantially zero machining gap with no arcing. Preferably, the electrode is a counter plate electrode, a sleeve journal electrode or a conical bearing electrode. Preferably, the surface of the conductive block comprises a groove pattern comprising grooves and flat or profiled non-flat lands between grooves.

Another embodiment relates to a method of manufacturing an electrode comprising forming a groove pattern in a dielectric layer on a conductive block by a laser or a focused energy beam having a pulse time of nanosecond or less to ablate portions of the dielectric layer. Preferably, the dielectric layer has a lower ablation threshold than that of a conductive material of the conductive block. Preferably, the laser ablation is performed with substantially no ablation of the conductive material of the conductive block. Preferably, the dielectric layer has a higher ablation threshold than that of a conductive material of the conductive block. Preferably, the laser ablation is performed by explosion and expulsion of the conductive material of the conductive block, resulting in simultaneous removal of the conductive material and a dielectric material of the dielectric layer overlaying the groove pattern area. Other embodiments could further comprise polymerizing a monomer to form the dielectric layer, wherein the monomer is a photoactive monomer. Preferably, the laser or the focused energy beam activates an insulating material and cause the insulating material to expand above or over a conductive portion of the electrode creating an insulating standoff.

Yet other embodiment relates to a method of manufacturing an electrode comprising forming a groove pattern on a surface of a conductive block by laser ablation of portions of the hollow conductive block and forming a dielectric material in the groove pattern. Preferably, the grooves have a feature width of 20 microns or less. Preferably, either the dielectric material in the groove pattern or non-flat lands between grooves has a curved surface. Yet other variation could further comprise and depositing a metal in the groove pattern. Preferably, the pulse time is less than 100 picoseconds. More preferably, the pulse time is between 1 picosecond to 1 femtosecond.

Still other embodiment of the invention relates to a workpiece comprising a groove pattern comprising a groove for fluid dynamics bearing, the groove pattern having a pitch of less than 100 microns and the groove having a substantially perpendicular wall formed by an electrode with a convex land. Preferably, the groove pattern has a feature width of 10 microns or less. Preferably, the groove pattern has a feature width of 20 microns or less at a gap of 5 microns or less. Preferably, the workpiece is a counter plate, a sleeve journal or a conical bearing.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention a property of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

The present invention will be better understood by reference to the Detailed Description of the Invention when taken together with the attached drawings, wherein:

FIG. 1 shows a schematic of a magnetic disc drive.

FIG. 2A is a vertical section of the spindle motor of FIG. 1. FIGS. 2B and 2C are vertical and horizontal sectional views of a portion of the motor, especially the shaft and thrust plate, illustrating the grooves which may be formed utilizing the present invention. FIG. 2D is a is a vertical sectional view of a hub utilized in a spindle motor in the disc drive of FIG. 1 showing a dual conical bearing which is of a type which may usefully be formed by the present invention.

FIG. 3 is a schematic of an electrode with hollow core.

FIG. 4 is a schematic of an electrode with filled core.

FIG. 5 is a schematic of an apparatus for forming grooves in a workpiece using ECM electrodes of the invention.

FIG. 6 shows fine feature width achieved in an electrode by the embodiments of the invention.

FIG. 7 shows a thrust electrode.

FIG. 8 is a schematic of shaped lands on the electrode and its effect on overburn and groove geometry.

FIG. 9 is a schematic of a conventionally fabricated electrode.

FIG. 10 is a schematic of an electrode made by direct ablation of a dielectric material with laser

FIG. 11 is a schematic of a recessed electrode made by selective curing of liquid photo-monomer.

FIG. 12 is a schematic of an electrode (recessed or leveled) made by selective curing of liquid photo-monomer in channels.

FIG. 13 a schematic of an electrode (recessed or leveled) made by selective curing of liquid photo-monomer with Laser followed by metal plating in grooves.

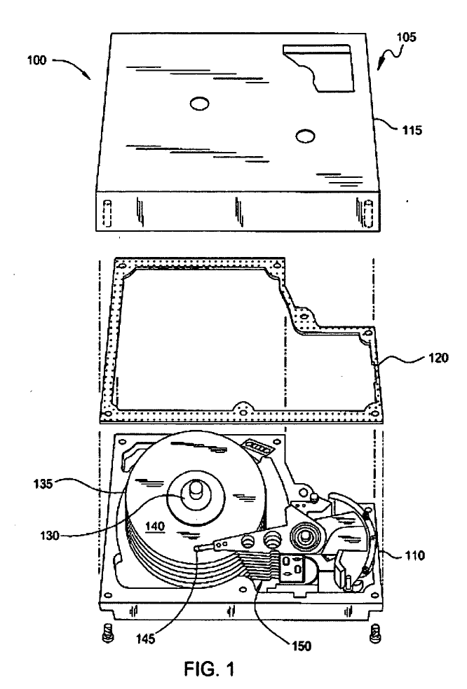

### DETAILED DESCRIPTION OF THE INVENTION

The basis for this invention is the recognition and demonstration by the inventors to make multi-dimensional variations to the land and the groove profile on the motor bearing components such as shafts, sleeves, cones, flat thrust surfaces etc. The embodiments of the invention allow one to make precise corresponding geometry on the electrode.

Among the embodiments of the invention, femtosecond pulsed laser machining method allows manufacture of fine features on the electrode. It is compatible with current potting process (casting of dielectric material into pre-machined grooves, followed by surface grinding to make dielectric surface flush with conductive element) and is a drop-in solution for attaining fine features and advanced geometries on the electrode. This electrode is compatible with traditional ECM process. In this embodiment the invention the materials used in the construction of the electrode may be of any density and hardness.

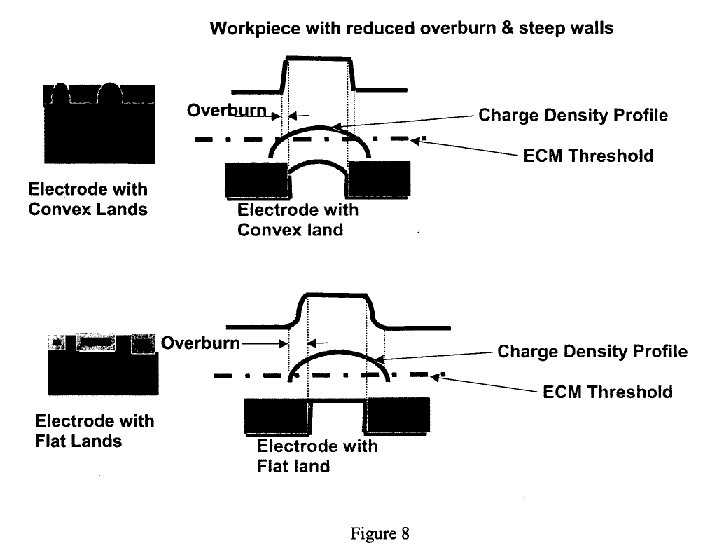

In the embodiments of the invention, the grooved parts of fluid dynamic bearings motors could be manufactured by means of electrochemical machining process (ECM). The groove shapes and widths as well as the groove density can be machined to optimize bearing performance. The grooves in some embodiments may serve the following functions:
as microchannels for fluid delivery and distribution;
for reduced overburn by land shaping on electrode (FIG. 8);
to purge air and prevent cavitations;
to optimize power consumption; and
to optimize bearing stiffness and damping characteristics.

Among the embodiments of this invention, electrochemical machining is a manufacturing technique that could be used to fabricate grooves on fluid dynamic bearing workpiece parts of various geometries. As explained above, the ECM apparatus consists of the electrode, the electrolytic bath, the workpiece part and the fixture that sets a specific gap between the electrode and the workpiece. Applying the electric potential at high electric currents through the gap allows for pattern transfer from the electrode to the surface of the workpiece part. The depth of the resulting groves depends mainly on the machining gap, the electric current, the ECM process time, shape and distribution of the flux field resulting from land profile on the electrode. The widths of the grooves as well as their shape and their density (the number of grooves per unit area of the part) are defined by the machining gap between the ECM electrode (ECM apparatus) and the workpiece, the electrolyte flow rate through the machining gap and the feature geometries of the ECM electrode. These factors could determine the width and wall straightness (squareness) of the grooves geometries on the part.

The widths of electrochemically machined grooves on the workpiece parts are generally larger than the original features on the electrode due to the phenomenon called the overburn. One of the main factors affecting the groove widths of the workpiece part is the electrode pattern feature widths.

The electrodes of the embodiments of the invention have a feature width of the electrode in the range of 1 to 100 microns, preferably 5 to 50 microns, and more preferably 10 to 20 microns. In one embodiment, the feature width of the electrode was 11 microns. By using the ECM process and the electrodes of the embodiment of this invention, one can produce high density grooves—three to five times the groove density as that produced by the conventional electrode which allows 100 micron minimum groove widths on the grooved part and the limited density of the grooves. For example, the embodiments of this invention produces grooves on a workpiece with a pitch in the range of 10 to 150 micron and preferably in the range of 50 to 100 microns with feature width of the workpiece in the range of 2 to 150 microns, preferably 5 to 100 microns, and more preferably 10 to 30 microns. In one embodiment, the pitch of the grooves on the workpiece was 80 microns (as compared to 200 microns pitch density of the grooves of a conventional workpiece) and the feature width of the workpiece was 20 microns.

The feature geometries (feature widths, depths and the wall straightness (squareness)) of the ECM electrode are defined by its manufacturing process. The ECM electrode is currently manufactured by means of the end milling process that limits the electrode feature widths to 35 microns (due to end mill cutting load and resulting distortion on land if it is too thin to withstand the cutting load). The electrode groove width made by end mills is limited by smallest end mill diameter which is typically 125 um. This limits resulting groove feature width and groove- density on the final ECM part.

In the course of this invention, the inventors found that the new generations of high performance motor products would require a significant reduction in the widths of the grooves to 20 microns and an increase in the groove densities per area (keeping 0.5 groove to pitch ratio) on the workpiece part as well as the wall straightness (straight vertical walls) on the workpiece part. To achieve these characteristics on the part the inventors recognized that it would be required to reduce the machining gap. Reduced machining gap in conjunction with fine feature width electrode could produce fine features on the ECM part.

To remedy the deficiencies of the conventional electrode design& manufacturing process, the inventors arrived at design and manufacturing processes applicable to improving the conventional electrode effectiveness as well as new ECM electrode design wherein the electrode is made out of a hollow cylindrical blank of conductive material. The groove pattern machined on the electrode would cut through the thickness of the conductive material. Two possible configurations are described below:

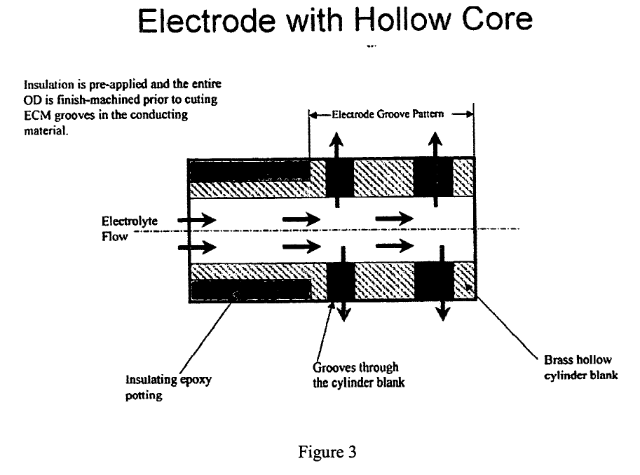

(1) Electrode with hollow core (FIG. 3): The groove pattern is machined through the conductive surface. The inside passage of the cylindrical blank is left open and could be used for pumping electrolyte through the exposed grooves. This is different from the present electrode designs where radial electrolyte flow holes are put in the journal or conical electrode.

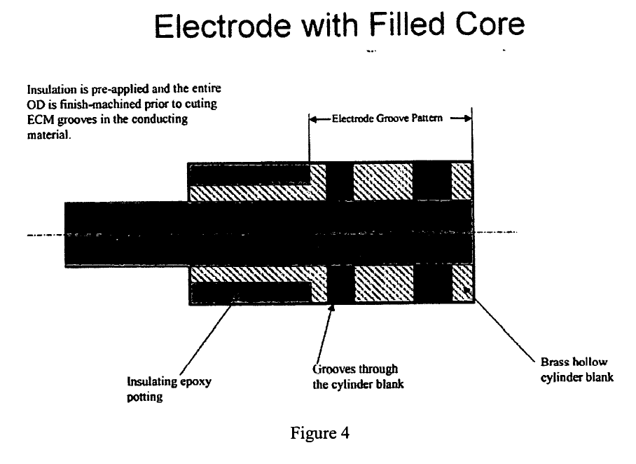

(2) Electrode with filled core (FIG. 4): A shaft made of an insulating material is cast, attached or plugged inside a hollow cylinder of a conductive material such as brass. Micro machining methods such as water-jet or laser machining processes which control energy threshold and peak power to selectively remove or ablate a top layer of the conductive cylinder can be used to cut out groove pattern from the conductive layer. The grooves in the conductive cylinder preferably completely penetrate the conductive layer of the conductive cylinder up to the insulating plug inside. The insulating plug could be used for providing structural stiffness to the electrode.

In the embodiments of the electrodes of this invention, since the groove channels are preferably ‘through’ grooves from the outer surface to the inner surface of the conductive hollow cylinder, there is no need for filling up the grooves with insulation to prevent short-circuiting between the conductive land regions of the conductive hollow cylinder.

Some of the advantages of the electrodes of the invention include:

1. The electrodes can have non-flat lands.

2. The electrodes can be made without post processing steps such as grinding of the potted layer.

3. The grooves in the electrodes can provide an additional path for the electrolyte flow through the electrodes during the ECM process.

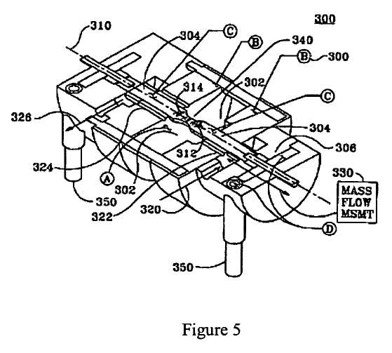

Even though FIGS. 4 and 5 show electrodes of cylindrical shapes, the electrodes of the embodiments of this invention could as well have other shapes such as being plate shaped, disc shaped, cone shaped, elliptical cross-sectional shape and other possible shapes. Also, the electrodes of this invention could be electrodes for a counter plate, a sleeve journal or a conical bearing.

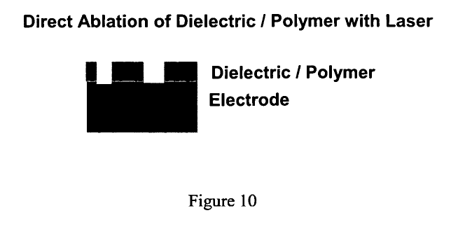

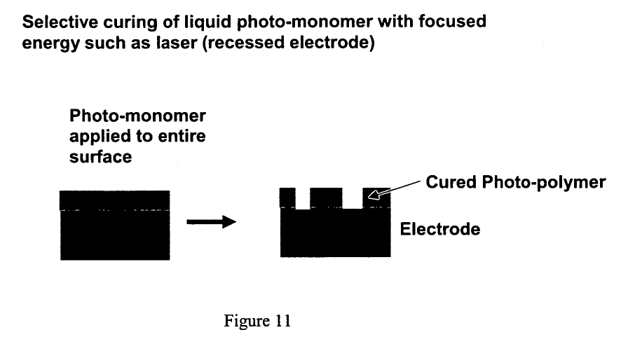

Some of the embodiments (FIG. 10, 11) of the electrodes of this invention have an electrode conducting surface located below the outer dielectric (non-conducting) surface of the electrode. The inventors found out that the electrodes of the embodiments of this invention have significant advantages with respect to workpiece part manufacturing. It allows for the reduction in the machining gap between the outer electrode surface and the workpiece part up to zero. The reduction in the machining gap leads to a reduction in the final groove widths on the part. The reduction in the machining gap in turn allows for an increase in the density of the grooves per area on the workpiece part and the increase in the groove wall straightness during the ECM process, which are desired parameters for good bearing performance.

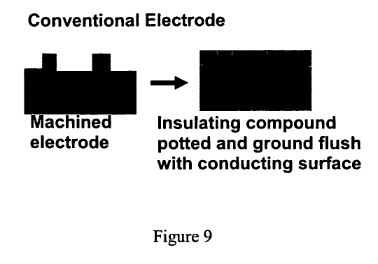

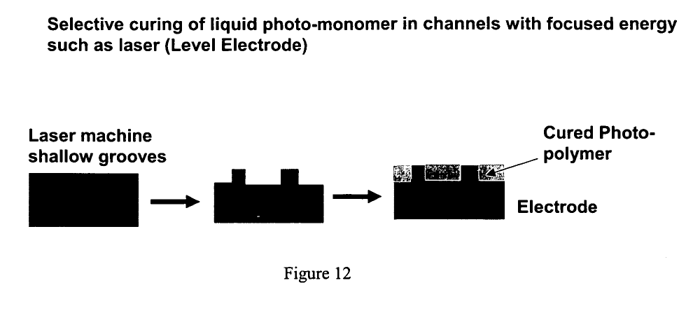

The electrodes of the embodiments of this invention could be made by microscopic or nanoscopic methods for machining of precise features for making ECM electrodes or by direct material buildup (FIG. 12) or removal (FIGS. 9, 10) using laser or other electromagnetic radiation that can be selectively focused on desired features or areas, as follows:

Option 1: A mechanical process using high energy superfine jets of liquid can be used to machine material in the groove area. The jet diameter and machining trajectory can be controlled to obtain the corresponding feature width.

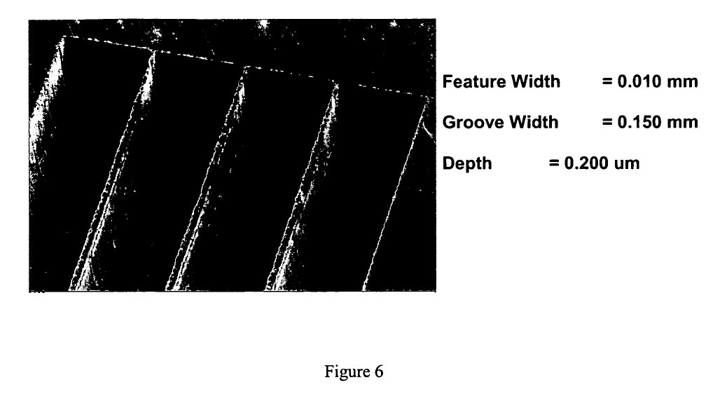

Option 2: Nanoscale machining using ultra fast laser: An ultra-short pulsed laser can be used at a very high intensity to selectively ablate features as small as 20 nanometers (FIG. 6).

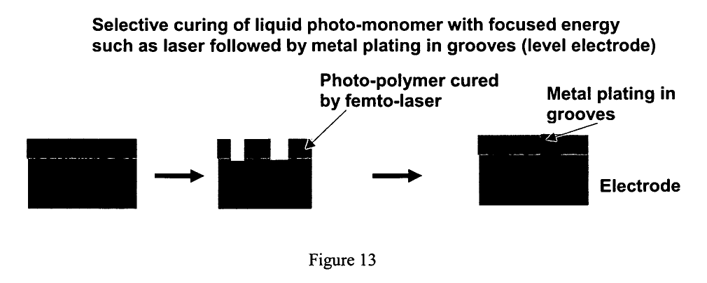

Option 3: Direct material build-up: This method starts by applying various layers of insulating (FIG. 10, 11) or conducting material (FIG. 13) that may be bonded, plated, solidified, or reactively catalyzed using this focused beam of energy. The material properties are changed only in the areas exposed to levels of energy above the change threshold. Because of the ability of this energy to be focused, directed, and varied in intensity in multiple dimensions, and with very high accuracy and resolution, it is possible to form single and multi-piece electrode structures of high complexity and precision. Materials used may be photon-activated polymers, monomer or other materials that are initially applied as a liquid, powder (solid) or gas. By applying and activating these materials in successive thin layers, with each layer integrated with or bonded to each underlying layer the resulting structure may vary in multiple dimensions, and with multiple properties.

Option 4: Direct material removal (ablation): The laser or electromagnetic energy source can be used to directly remove (ablate) material. It can be used to prepare or machine surfaces or structures prior to material buildup (see Option 3) or for finish machining or material removal after material buildup (FIG. 8).

These methods can also be applied to machine precise features such as recirculation holes and grooves. Some of the advantages of these methods include:

1. These processes can machine extremely fine features in the range of 50 nm width. This allows higher groove density.

2. The processes are relatively clean.

3. The processes could be more reproducible compared to current processes for making electrodes.

4. These processes differ from photolithographic masking and chemical or reactive etching as having reduced number of process steps than in the photolithographic masking process.

5. These processes allow the fabrication of multidimensional structural shapes that are difficult or impossible with other techniques. For example, finer land widths at the top and increasing feature width towards bottom. Here, the root of the lands can be made substantially wider than the top of the lands. This provides structural strength for narrow lands exposed on top. This can not be achieved by conventional milling process.

6. These processes allow fabrication of micrometer or nanometer scale features in the electrodes, motor components or any other components.

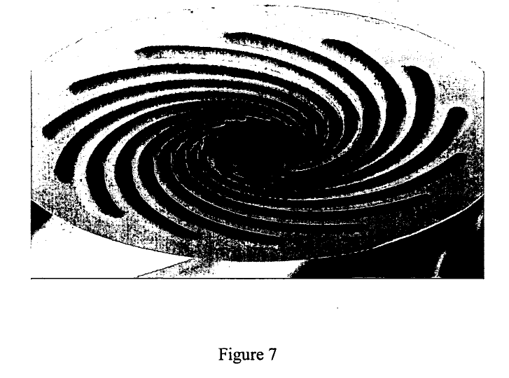

The electrodes of the embodiments of this invention has been successfully manufactured (e.g., the thrust electrode of FIG. 7) by the inventors with minimum electrode feature sizes of about 10 to 12 microns and tested in the ECM process to produce the minimum groove width on the workpiece part of about 20 to 50 microns at about 5 to 20 micron gap.

The electrodes of the embodiments could also be manufactured as described below, for example.

Step 1: Formation of a groove pattern in a dielectric layer on a hollow conductive block.
Option (a): Coat a dielectric layer on a conductive block. Ablate portions of the dielectric layer by laser to form grooves up to the surface of the conductive block or recessed within the conductive block. If the dielectric layer has lower ablation threshold than that of the conductive block, then ablate the dielectric layer with minimum disturbance to the conductive block. If the dielectric material of the dielectric layer has a higher ablation threshold than that of the conductive block, then the groove formation could be accomplished by explosion and expulsion of the conductive material of the conductive block by focused laser beam, resulting in simultaneous removal of the conductive material and the dielectric material above it in the groove pattern area.
Option (b): Coat a photoactive monomer or any material that can be cured by laser or light or other focused energy source on a conductive block. Polymerize the photoactive monomer or other material to form a dielectric layer on the conductive block. Ablate portions of the dielectric layer by laser to form grooves up to the surface of the conductive block or recessed within the conductive block. If the dielectric layer has lower ablation threshold than that of the conductive block, then ablate the dielectric layer with minimum disturbance to the conductive block. If the dielectric material of the dielectric layer has a higher ablation threshold than that of the conductive block, then the groove formation could be accomplished by explosion and expulsion of the conductive material of the conductive block by focused laser beam, resulting in simultaneous removal of the conductive material and the dielectric material above it in the groove pattern area.

Step 2: Deposition of a metal in the groove pattern. Using the dielectric layer to serve as a plating mask, the grooves in the groove pattern are plated by electrolytic or electroless methods to fill the grooves with a conductive material and form a flush surface on the electrode (FIG. 13).

The electrodes of the embodiments could also be manufactured as described below, for example.

Step 1: Formation of a groove pattern in a hollow conductive block. Grooves are laser machined on the surface of the conductive block.

Step 2: Formation of a dielectric material in the groove pattern. Coat a photoactive monomer or any material that can be cured by laser or light on a conductive block having a hollow core so as to fill the grooves of the groove pattern. Polymerize the photoactive monomer or other material to cure the dielectric material and form a flush surface on the electrode.

By the methods embodiments of this invention, the electrodes could have grooves having a feature width of 20 microns or less, more preferably 11 microns or less. Also, either the dielectric material in the groove pattern or land areas between grooves (FIG. 8) could have a curved surface to prevent overburn during the formation of grooves in the workpiece by focusing or shaping the electric field on the workpiece during the ECM process.

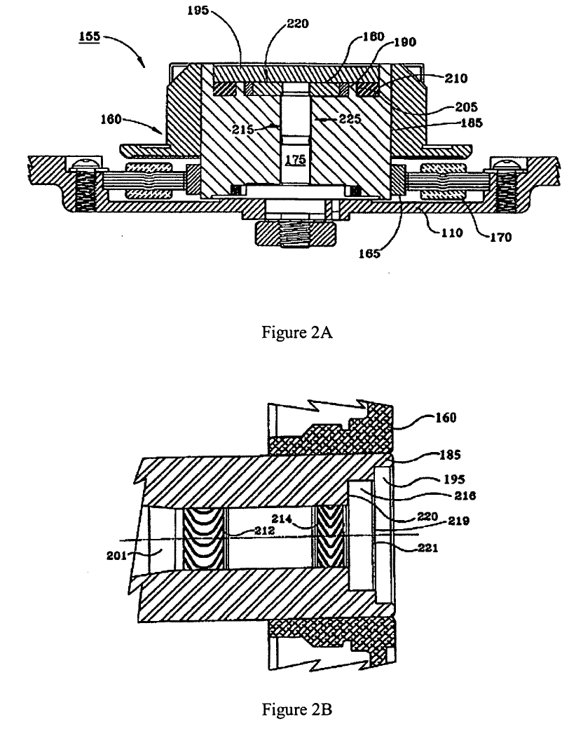

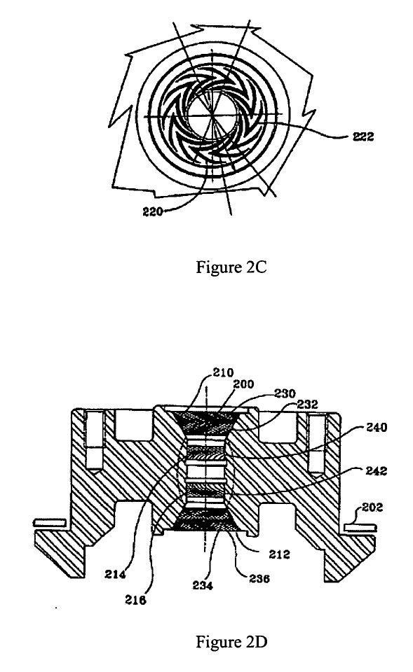

The apparatus for forming grooves in a workpiece using an ECM electrode of the embodiments of this invention is shown especially in FIG. 5. The work piece, such that shown in FIG. 2D, is placed within the frame 300; as can be seen the frame 300 is configured to define a cavity 302 which has a pair of electrodes 304 running through the center. When the work piece 200 is placed in the cavity 302, it is generally held firmly in place within the edges of the framing pieces 306. The electrodes 304, which are axially movable along axis 310, each include both a conical region 312 which will cooperate with the internal cones 210 and 212 of the hub 200, and a journal region 314 extending from a narrow end of the conical region which will cooperate with the internal hub journals 240 and 242, respectively.

When the work piece 200 is in place in the frame 300, the electrodes 304 are moved back and forth along the axis 310 until the gap between each electrode and the facing surface of the work piece is established. It can be seen, as generally represented in the figure, that each of the electrodes 304 carries the pattern which is to be imposed on the inner surface of the conical 201, 212 and journal regions 214, 216 of the work piece 200. It is also readily apparent that the problem remaining is to accurately set the gap, which must be measured in microns, between the movable electrodes and the work piece 200 which is being held in place in the frame, and to do so quickly and repetitively on a high speed basis.

In other variations of the invention, the use of reversed ECM polarity would change the direction of charge flow through the electrolyte. As a result, the lands on the conductive block can be eroded. The process can be controlled to recess the lands below the insulating surface by a desired amount. Such an electrode can be used with tight machining gaps in order to minimize overburn.

In this application, the word “containing” means that a material comprises the elements or compounds before the word “containing” but the material could still include other elements and compounds. This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. An electrode comprising a conductive block having a first opening though the conductive block and a second opening through the conductive block, the second opening traversing from the first opening to a surface of the conductive block.

2. The electrode of claim 1, wherein the first opening does not contain a solid plug and the second opening is configured to allow the flow of a fluid through the second opening.

3. The electrode of claim 1, wherein the first opening contains a solid plug comprising a non-conducting material.

4. The electrode of claim 1, wherein the electrode is configured to form a groove pattern on a workpiece by an electrochemical machining process.

5. The electrode of claim. 1, wherein the surface of the conductive block comprises a groove pattern comprising grooves having a feature width of 25 microns or less.

6. The electrode of claim 1, wherein the surface of the conductive block comprises a groove pattern comprising grooves having a feature width 12 microns or less.

7. The electrode of claim 1, wherein the first opening and the second opening contain no dielectric material.

8. The electrode of claim 1, wherein the electrode is configured to form a groove pattern in a workpiece at substantially zero machining gap with no arcing.

9. The electrode of claim 1, wherein the electrode is a counter plate electrode, a sleeve journal electrode or a conical bearing electrode.

10. The electrode of claim 1, wherein the surface of the conductive block comprises a groove pattern comprising grooves and flat or profiled non-flat lands between grooves.

11. A method of manufacturing an electrode comprising forming a groove pattern in a dielectric layer on a conductive block by a laser or a focused energy beam having a pulse time of nanosecond or less to ablate portions of the dielectric layer.

12. The method of claim 11, wherein the dielectric layer has a lower ablation threshold than that of a conductive material of the conductive block.

13. The method of claim 12, wherein said laser ablation is performed with substantially no ablation of the conductive material of the conductive block.

14. The method of claim 11, wherein the dielectric layer has a higher ablation threshold than that of a conductive material of the conductive block.

15. The method of claim 14, wherein said laser ablation is performed by explosion and expulsion of the conductive material of the conductive block, resulting in simultaneous removal of the conductive material and a dielectric material of the dielectric layer overlaying the groove pattern area.

16. The method of claim 11, further comprising polymerizing a monomer to form the dielectric layer, wherein the monomer is a photoactive monomer.

17. The method of claim 11, wherein the laser or the focused energy beam activates an insulating material and cause the insulating material to expand above or over a conductive portion of the electrode creating an insulating standoff.

18. A method of manufacturing an electrode comprising forming a groove pattern on a surface of a conductive block by ablation of portions of the conductive block and forming a dielectric material in the groove pattern.

19. The method of claim 18, wherein the grooves have a feature width of 20 microns or less.

20. The method of claim 19, wherein either the dielectric material in the groove pattern or non-flat lands between grooves have a curved surface.

21. The method of claim 11, further comprising depositing a metal in the groove pattern.

22. The method of claim 11, wherein the ablation is by laser having a pulse time is less than 100 picoseconds.

23. The method of claim 11, wherein the ablation is by laser having a pulse time is between 1 picosecond to 1 femtosecond.

24. A workpiece comprising a groove pattern comprising a groove for fluid dynamics bearing, the groove pattern having a pitch of less than 100 microns and the groove having a substantially perpendicular wall.

25. The workpiece of claim 24, wherein the groove pattern has a feature width of 10 microns or less.

26. The workpiece of claim 24, wherein the groove pattern has a feature width of 20 microns or less at a gap of 5 microns or less.

27. The workplace of claim 24, wherein the workpiece is a counter plate, a sleeve journal or a conical bearing.

28. The workplace of claim 24, wherein the substantially perpendicular wall is formed by an electrode with a convex land.
